(19) United States
(12) Patent Application Publication
(10) Pub. No.: US 2002/0124447 A1
(43) Pub. Date: Sep. 12, 2002

(54) Mast-supported display system

(76) Inventor: Edward Allen Burke, Utopia (CA)

Correspondence Address: D.W. EGGINS, 18 DOWNSVIEW DRIVE, BARRIE, ON, L4M 4P8, CA

(21) Appl. No.: 10/141,187

(22) Filed: May 9, 2002

Related U.S. Application Data
(63) Continuation-in-part of application No. 09/458,179, filed on Nov. 19, 1999.

(51) Int. Cl. G09F 15/00; G09F 7/22

(52) U.S. Cl. 40/606; 40/617

(57) ABSTRACT

An outdoor advertising system has a lightweight hollow mast; a mounting base for the mast; a direct-insert anchor securing system; and a range of three dimensional artifacts, and banners that are weather insensitive. The mast mounts on the base, having lightweight fittings, including a top-mounted rotatable cantilever arm enabling the arm and its banner to “weathervane” in the wind. An ovoid hooped frame embodiment pivotally cantilevered from the mast, supports a sleeved banner like a wind-sock. The ovoid shape provides effective side display areas. Another elongated banner embodiment with several triangular banners in spaced angular relation as a form of tree encloses the mast, with the bottom outer corners of the banners ground anchored, serving as mast stays. A drinking cup embodiment may be mounted about the mast. The fabric artifacts stand up to fourteen feet in height.

### CROSS REFERENCE TO RELATED APPLICATIONS

Continuation-in-Part of application Ser. No. 09/458,179 filed Nov. 19, 1999

### STATEMENT REGARDING FEDERALLY SPONSORED RESEARCH OR DEVELOPMENT

Not applicable

### REFERENCE TO MICROFICHE APPENDIX

Not applicable

### BACKGROUND OF THE INVENTION

1. This invention is directed to out-door display systems and in particular to removable standing emblems such as advertisements and their associated support structures.

2. Businesses throughout the world are heavily dependent upon advertising, in order to promote their identity in relation to their premises and their products. The predominance in the western world of personal transportation by automobile has focussed much attention upon roadside advertisement and displays. In order to meet the perceived needs of business in this context, and in view of the requirements of controlling local legislation, many and various approaches have been adopted, ranging from stationary trailers and vehicles featuring large exposed side areas bearing advertisements, to portable frames with bill-board style advertising, to masts and flagpoles bearing banners and flag-like displays. One aspect in this field of activity is the matter of economics, in terms of the cost to provide a preferred advertising amenity. In addition to material costs, labour costs also form an important consideration. For instance, an outdoor display system that uses a mechanical support system such as a mast or hoarding that is dependent upon excavation, and the pouring and setting of cement, is labour intensive, time consuming, and frequently employ large, heavy, costly structures. Also, the time required for the setting up of the cement usually necessitates a second visit to the site. Such activity is seasonally very vulnerable to low temperatures, particularly as experienced in the more northerly States and in Canada.

### BRIEF SUMMARY OF THE INVENTION

The present invention provides a system for outdoor, year-round display advertising, including a lightweight mast; a mounting base for securing the mast; a direct-insert anchoring system for securing the display; and a range of displays for use with the mast, including three dimensional artifacts, and banners that are substantially invulnerable to all but the most extreme natural elements.

The subject base anchoring system uses ground anchors of the type disclosed in U.S. Pat. No. 5,613,329 Land, March 1997. In addition, lightweight masts of metal tubing are mounted upon the base.

It will be evident that other forms of ground anchor may be used with these displays.

The mast is used in combination with light-weight specialty fittings, including a top-mounted cantilever arm that is rotatably secured to the mast, enabling the arm and its associated banner to “weathervane”, in response to the direction of the wind.

The cantilever arm may be non-linear, such as a semi-circle i.e. half-hoop, from which a correspondingly shaped banner can be suspended. This banner may be downwardly tapered to the mast.

Similarly, in another embodiment a hooped frame is cantilevered from the mast, being also capable of pivotting about the mast. The frame may have an inner hoop located adjacent to, and parallel with the mast and having at least two rods projecting sensibly horizontally therefrom. The two rods support a second, outer hoop positioned parallel with the first hoop. This frame can support a sleeve-like banner in the manner of a wind-sock. The hoops may be round, but are preferably oval, for purposes of providing a more effective display area.

In another embodiment, a central sleeve that is fitted over the length of the mast has a plurality of triangular banners extending radially from the sleeve in mutually spaced angular relation, as a form of tree, with the respective triangular banner surfaces suitably decorated. The bottom outer comers of the triangular banners may be anchored, such as by pin-anchors to the ground, and serve as stays for the mast. This embodiment can be surmounted by a flag, such as a house flag, mounted upon an upward extension of the mast.

A drinking cup embodiment, as disclosed in the above-identified copending application may be mounted about the subject mast, being supported and shaped by internal elements mounted upon the mast.

Emblems such as this may be of considerable size; e.g. six feet in height and of proportional diameter.

### BRIEF DESCRIPTION OF THE SEVERAL VIEWS OF THE DRAWINGS

Certain embodiments of the invention are described by way of illustration, without limitation thereto other than as set forth in the accompanying claims, reference being made to the accompanying drawings, wherein:

FIG. 1 is a perspective view showing a mounting base for receiving a mast, together with its direct insert ground-anchor system elements;

FIG. 2 is a front perspective view of a portion of a ground-anchor element and a socket drive, in part-section

FIG. 3 is a side elevation of a mast with a top mounted cantilever arm, together with an example, to a smaller scale, of a flag and a banner in use therewith;

FIG. 4 is a side elevation in exploded relation of the elements of a mast embodiment having a semi-circular top extension support;

FIG. 5 shows a tapered banner in mounted relation on the FIG. 4 embodiment;

FIG. 6 is a side elevation showing a horizontally projecting hooped frame embodiment;

FIG. 7 is an end view of the FIG. 6 embodiment;

FIG. 8 is a side perspective view of a form of three-dimensional banner for use with the embodiment of FIGS. 6 and 7;

FIGS. 9 and 10 show two mast-mounted embodiments of the FIG. 8 three-dimensional banner;

FIG. 11 is an exploded view showing the support elements of a cup embodiment;

FIG. 12 is a perspective view from above of the cup embodiment;

FIG. 13 is a front perspective view of a pyramidal display embodiment; and,

FIG. 14 is an artist's impression showing a FIG. 13 embodiment in use.

### DETAILED DESCRIPTION OF THE INVENTION

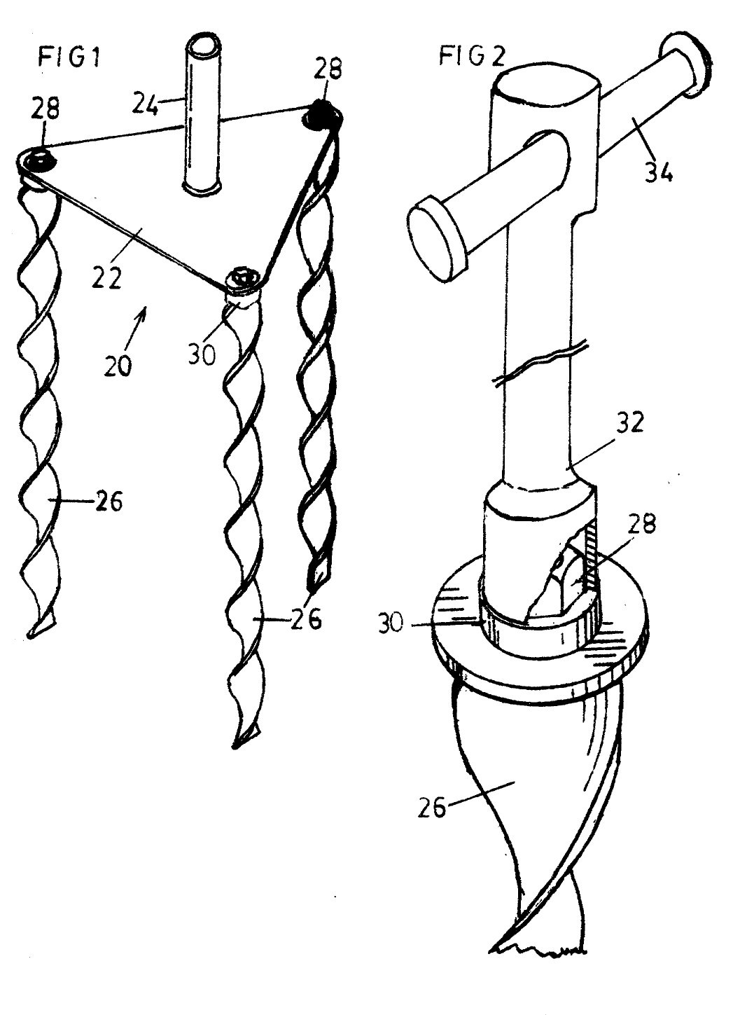

Referring to FIGS. 1 and 2, an anchor base 20 has a triangular baseplate 22 with a central spigot 24. Bolts 28 attach the base 20 to three spiral earth anchors 26.

The earth anchors 26, which are usually about two feet long, each have an internally threaded head portion 30 to receive the bolts 28, which serve as connectors by which a hexagonal socket drive 32 equipped with a torque arm 34 is used to screw the anchors 26 into the ground. A jigplate (not shown) is used to locate and control the anchors 26 during their insertion into the ground, after which the baseplate 22 is installed, and bolted into place, using the bolts 28.

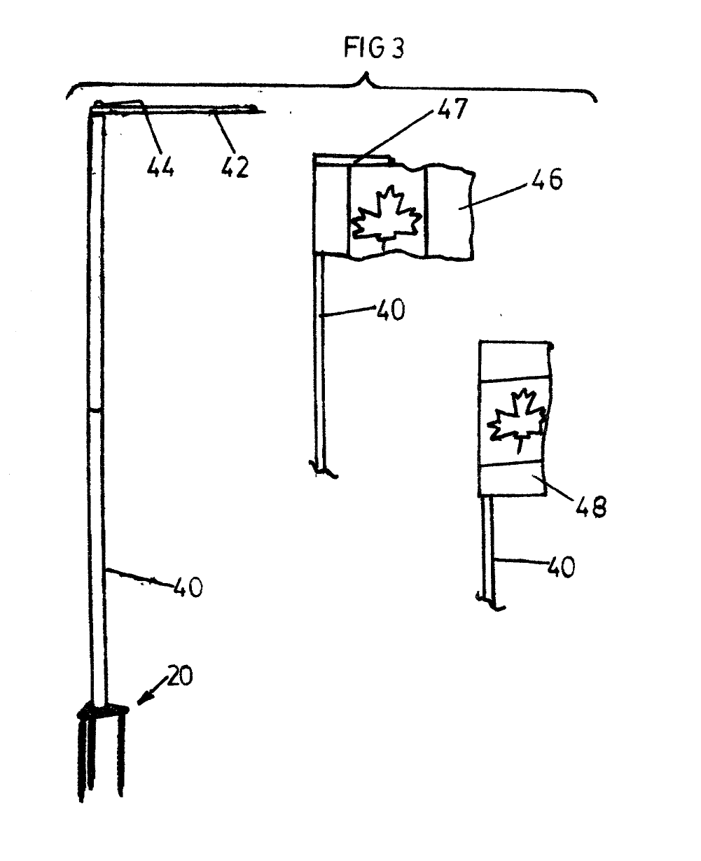

Turning to FIG. 3, a mast 40 is shown, being in two sections and illustrated in relation to an anchor base 20. A cantilevered pivot arm 42 is rotatably mounted upon a boss portion 44 of the mast 40, the arm 42 having the freedom to rotate 360 degrees in a horizontal plane, about the boss 44.

A simulation of a Canadian flag 46 is shown, mounted from the arm 42 by way of a top sleeve portion 47, and having a sleeve portion of the flag wrapped in concealing relation about the top of the mast 40. It will be observed that the outer end of the flag is free and unrestrained.

An elongated banner 48 incorporates the elements of the Canadian flag and is wholly mounted in concealing relation over the arm 42 and the adjoining portion of the mast 40.

A three foot pivot arm 42 is well suited to a five foot flag 46, and to a vertical banner seven feet long.

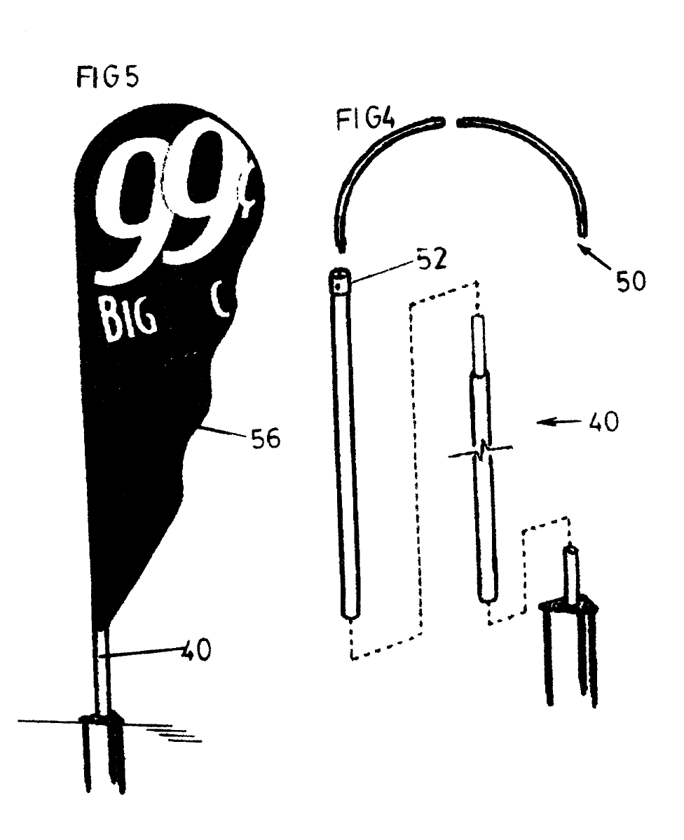

Turning to FIGS. 4 and 5, a two piece semi-circular cantilever arm 50 is attached to a two-piece mast 40 by way of a rotatable sleeve 52, which sits on the top of the mast 40. The sleeve 52 has an axial aperture in which the narrow end of the arm 50 forms a push fit. The two portions of the arm 50 form a peg-and-socket connection.

A tapered banner 56 fits over the arm 50 and envelops a large portion of the mast 40, standing as tall as fourteen feet, and being free to weathervane in accordance with the wind, while also presenting minimum wind resistance.

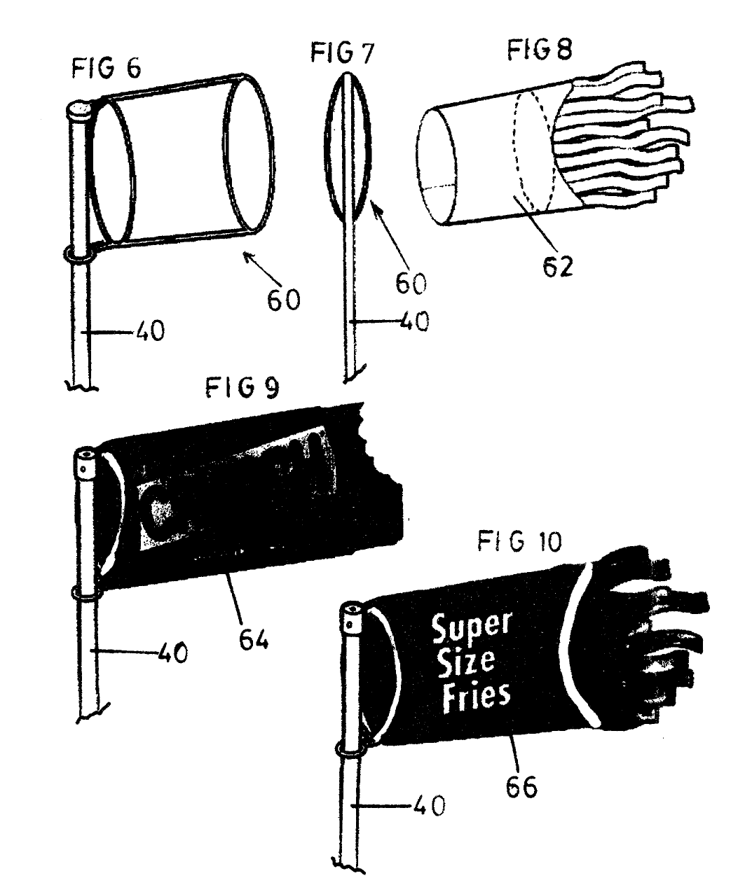

Turning to FIGS. 6 through 10, FIGS. 6 and 7 show a mast 40 having a cantilevered ovoid framework 60 rotatably mounted at the top of the mast 40.

FIG. 8 shows a cylindrical banner 62 that fits over and is secured to the framework 60, and which depicts a cup of french fries.

FIG. 9 shows a banner 64, similar to that of FIG. 8, depicting a partially eaten chocolate bar; and FIG. 10 depicts a banner 66, similar to banner 62.

The ovoid shape of the banners 62, 64 and 66 provides an effective display area on each side of the banner. The rotatable mounting of the frame 60 permits weathervaning by the banners 62, 64 and 66.

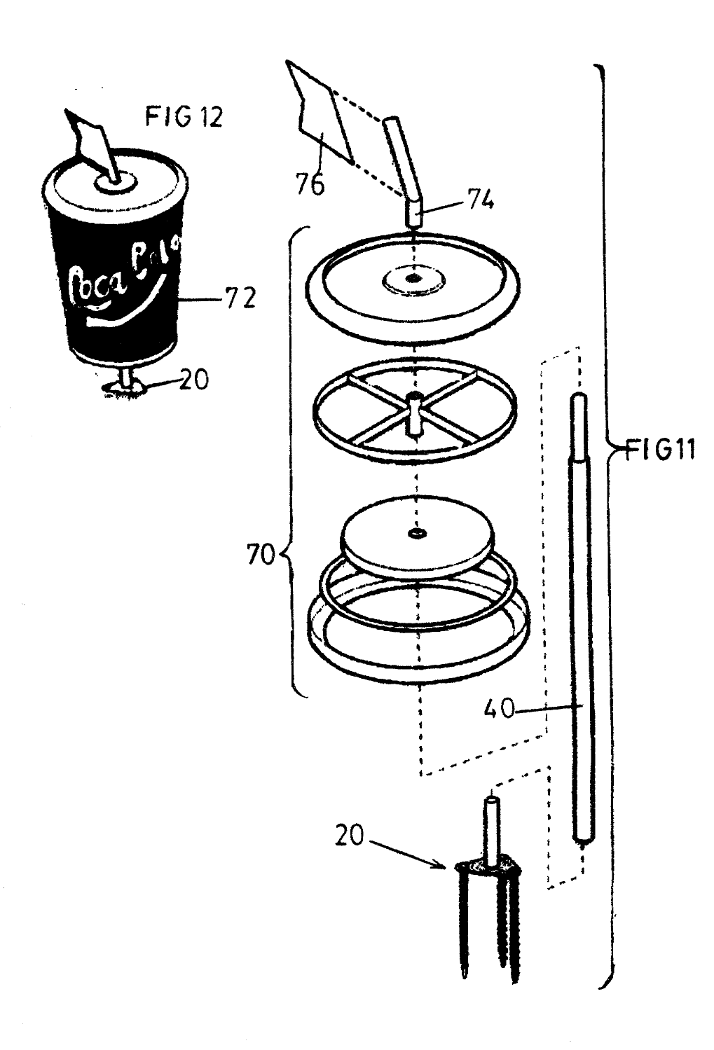

In FIGS. 11 and 12 an anchor base 20 supports a mast 40 on which are mounted the frame elements 70 of a banner 72 depicting a cup. An upstanding element 74 depicting a straw carries a miniature banner 76. An actual embodiment of the cup depiction 72 stands six feet tall.

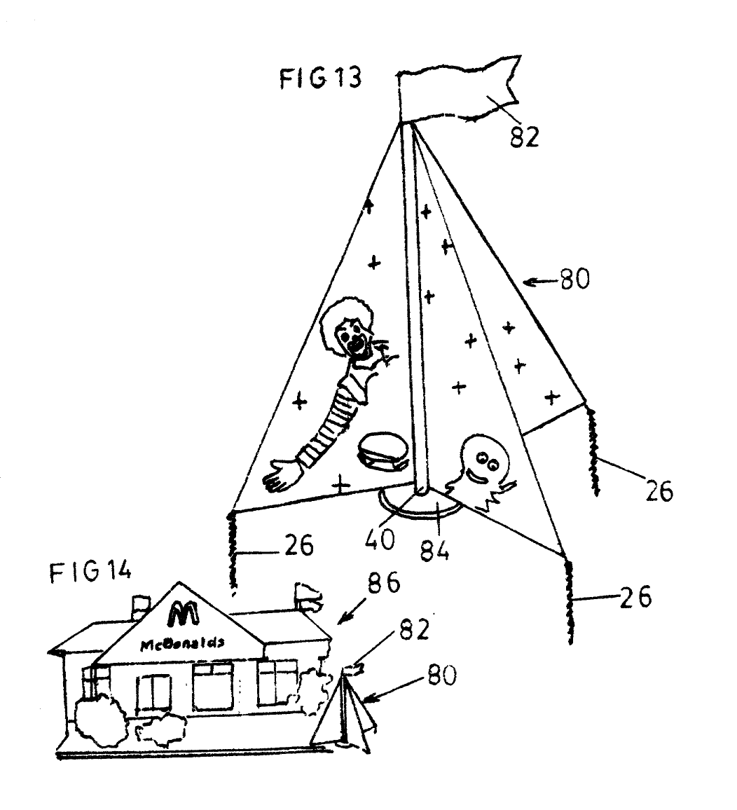

Turning to FIGS. 13 and 14, a multi-sided banner 80 is mounted upon a mast 40. The mast 40 is supported by a base 84, and braced by way of earth anchors 26, which hold the tent-like sides of the banner 80 in tensioned relation. The banner 80 is surmounted by a banner 82. The combined display 80/82, an embodiment of which stands ten feet tall, is shown in a typical situation in front of an establishment 86, which the banners 80/82 advertise. The banner 80 particularly lend itself to being illuminated with floodlights.

1. A combination display, having a mast mounted upon a base; a banner mounted upon the mast; and removable earth anchor means in anchoring relation with the display, wherein said display is readily erected and anchored; said mast being of hollow, lightweight construction, and said banner being of light-weight material.

2. The combined display as set forth in claim 1, said base having a baseplate with an upstanding spigot to receive said mast in superposed relation over the spigot.

3. The combined display as set forth in claim 1, said earth anchor means consisting of a plurality of spiral earth anchors on mutually spaced relation engaging said base.

4. The combined display as set forth in claim 1, said banner having a plurality of side portions in mutually inclined relation; said earth anchor means consisting of a plurality of spiral earth anchors, each one engaging a said banner side portion in tensioning relation, to brace said mast in a substantially upright position.

5. The combined display as set forth in claim 4, said earth anchors each having an internally threaded head portion to receive bolts serving as connectors for a torque arm, in use to screw the anchors into the ground.

6. The combined display as set forth in claim 1, said mast being in two sections, and having a cantilevered pivot arm rotatably mounted upon a boss portion of the mast, said arm having the freedom to rotate 360 degrees in a horizontal plane, about the boss.

7. The combined display as set forth in claim 6, said banner being mounted from said arm by way of a top sleeve portion, and having a sleeve portion of the banner wrapped in concealing relation about the top of said mast, the outer end of the banner being free and unrestrained.

8. The combined display as set forth in claim 6, said cantilever arm being of two piece semi-circular form, and attached to said mast by way of a rotatable sleeve, mounted on the top of the mast.

9. The combined display as set forth in claim 6, said banner fitting over said arm and enveloping a large portion of said mast, being free to weathervane in accordance with the wind, while presenting minimum wind resistance.

10. The combined display as set forth in claim 1, said banner including a cantilevered ovoid framework rotatably mounted at the top of said mast.

11. The combined display as set forth in claim 10, said ovoid framework giving said ovoid shape to said banner, to provide an effective display area on each side of the banner, said rotatable framework permitting weathervaning by said banner.

12. The combined display as set forth in claim 1, said banner being downwardly and inwardly tapered, and having a convex upper end.

13. The combined display as set forth in claim 1, said light-weight material being selected from the group consisting of knitted and woven fabric.

14. The combined display as set forth in claim 13, wherein said woven fabric is air permeable.

15. The method of displaying a banner, consisting of the steps of mounting a mast upon a base; suspending a banner from the mast, and securing said mast in a substantially vertical position.

16. The method as set forth in claim 15, wherein said base is secured by a plurality of earth anchors inserted into the ground.

17. The method as set forth in claim 15, said banner having a plurality of sail-like portions in mutually spaced relation about said mast; including the step of securing a plurality of said said sail-like portions in tensioned relation, each by way of an earth anchor, to thereby brace said mast in a substantially upright condition.
